(19) United States
(12) Patent Application Publication
(10) Pub. No.: US 2006/0004846 A1
(43) Pub. Date: Jan. 5, 2006

(54) Low-overhead relational database backup and restore operations

(75) Inventors: Michael Murley, Austin, TX (US); Stanley James Dee, Austin, TX (US); Richard Cline, Austin, TX (US)

Correspondence Address: WONG, CABELLO, LUTSCH, RUTHERFORD & BRUCCULERI,;P.C., 20333 SH 249, SUITE 600, HOUSTON, TX, 77070, US

(73) Assignee: BMC Software, Inc., Houston, TX (US)

(21) Appl. No.: 10/869,220

(22) Filed: Jun. 16, 2004

(51) Int. Cl. G06F 17/00

(52) U.S. Cl. 707/103 R

(57) ABSTRACT

A low-overhead relational database backup operation includes creating a single output file object in which a plurality of database tablespaces are stored. The number of tablespaces may be arbitrarily large. Because multiple output file objects are not created, the backup operation eliminates the overhead associated with allocating, opening, deallocating and closing multiple output file objects. Where the number of tablespaces is large, this reduced overhead processing can significantly the speed of backup operations.

### BACKGROUND

The invention relates generally to computer database systems and more particularly to backup (and restore) operations associated with relational database systems.

Business environments are becoming progressively more complex for companies of all sizes. Much of this complexity arises from the growing amount of information it takes to conduct business and the many users and uses of this information. In these environments, a corporation's data sources may become its number one asset. Compounding this general trend, the rapidly growing areas of e-business, data warehouses and enterprise resource management require data be delivered quickly and efficiently without failure. These applications typically use relational databases as their data source, with the databases forming the foundation of the corporation's computing architecture. Since these databases act as the corporate data server, they can quickly turn into a single point of failure crippling and entire organization should they fail.

Database system failures can result from, for example: system outages (e.g., power, hardware and software failures); transaction failures (e.g., users inadvertently corrupting a database by modifying it with incorrect data); media failures (e.g., disk access problems); and disasters (e.g., physical plant damage caused by fires or flooding). For these reasons, database managers routinely backup their databases. Backups typically include not only the data being backed up, but also information about the structure of the database (i.e., metadata). In a relational database system, this metadata may include information about the tablespaces, containers, database configuration, log files and recovery history associated with the database object being backed-up. As used herein, the term “backup” means a copy/image of a complete database or a portion of a database. For example, prior art relational database systems permit users to backup a complete database (tables and indices), one or more designated tables, or one or more partitions of a partitioned table.

Referring to FIG. 1, prior art relational database backup operation 100 generates one backup file (object) for each table or tablespace being backed-up. As shown, a user first identifies those tablespaces to be backed up (block 105). A first tablespace is then selected (block 110) and an output file for the selected tablespace is allocated (block 115). Allocating an output file has the effect of gaining access to, and control of, the output device on which the output file is to be stored. Thus, if the output file is to be stored on a magnetic tape device, the acts of block 115 would result in backup process 100 obtaining authorization to write to the targeted tape unit. The allocated output file is then opened (block 120) and data from the identified tablespace is obtained (block 125) and written to the output file (block 130). Once all of the identified tablespace's data has been written, the output file is closed (block 135). Next, the output file is cataloged (block 140) and a database system copy log file is updated (block 145). Following the cataloging operations of blocks 140 and 145, the output file is deallocated (block 150). If at least one tablespace identified during the acts of block 105 remains to be backed up (the “No” prong of diamond 155), a “next tablespace” is identified (block 160) whereafter processing continues at block 115. If all the tablespaces identified during the acts of block 105 have been backed up (the “Yes” prong of diamond 155), backup processing is complete.

It is clear from FIG. 1 that prior art backup operation 100 generates one output object or file for each tablespace (or partition thereof) being backed up. In large database systems where tape backup media is often used, the time required to allocate an output file (block 115), open the file (block 120), close the file (block 135), catalog the output file (block 140) and update the system catalog (block 145) can be significant—in the range of 2 to 4 seconds for each output file. For backup operations directed to tablespaces having a significant amount of data, the time required to perform these operations may be insignificant compared to the time to backup the targeted information. However, for backup operations directed at relatively small tablespaces and particularly in situations in which a large number of small tablespaces are being backed up, the time required to perform these operations can be greater than the time required to actually back up the targeted tablespaces' data.

In many modern database systems, such as Enterprise Resource Planning (ERP) systems, a single application may comprise a large number of tablespaces—the majority of which may be substantially empty at any given time or for any given implementation. In these situations, the time required to backup an application may be dominated by the time to open, close and catalog each tablespace's output file. For example, an SAP® ERP application can comprise upwards of 40,000 tablespaces “out of the box.” (“SAP” is a registered trademark of SAP Aktiengesellschaft, a joint stock company of the Federal Republic of Germany.) Many of these tablespaces will be empty (or nearly so) for any given business implementation. To backup the application, however, each tablespace must be backed up. Even if 90% of the 40,000 tablespaces are empty, the time to back these up (at 3 seconds per output file generation) comes to 30 hours! That is 30 hours spent opening, closing and cataloging essentially empty files.

Thus, it would be beneficial to provide techniques (methods and devices) to efficiently backup database tablespaces—especially, but not limited to, the situation wherein one or more of the tablespaces to be backed up contain an insubstantial amount of data or information.

### SUMMARY

In one embodiment the invention provides a method to backup, copy or image a relational database system. The method includes obtaining access to an output file (typically through the acts of allocating and opening the output file), obtaining data associated with a tablespace, writing the obtained data to the output file and repeating the acts of obtaining data and writing data for at least one additional tablespace. Once data from the plurality of tablespaces has been written to the output file, access to the output file may be relinquished (typically through the acts of deallocating and closing the output file). In addition, the output file may be cataloged for subsequent use. In another embodiment, the invention uses the output file (indicating that a plurality of tablespaces have been stored to a common, or single, output file) to restore one or more tablespaces. In one specific embodiment, the output file is a magnetic tape-based output file. Methods in accordance with the invention may be stored in any media that is readable and executable by a computer system. In another embodiment, the invention provides a computer database backup system for performing the acts just described.

### BRIEF DESCRIPTION OF THE DRAWINGS

FIG. 1 shows, in flowchart form, a prior art backup operation.

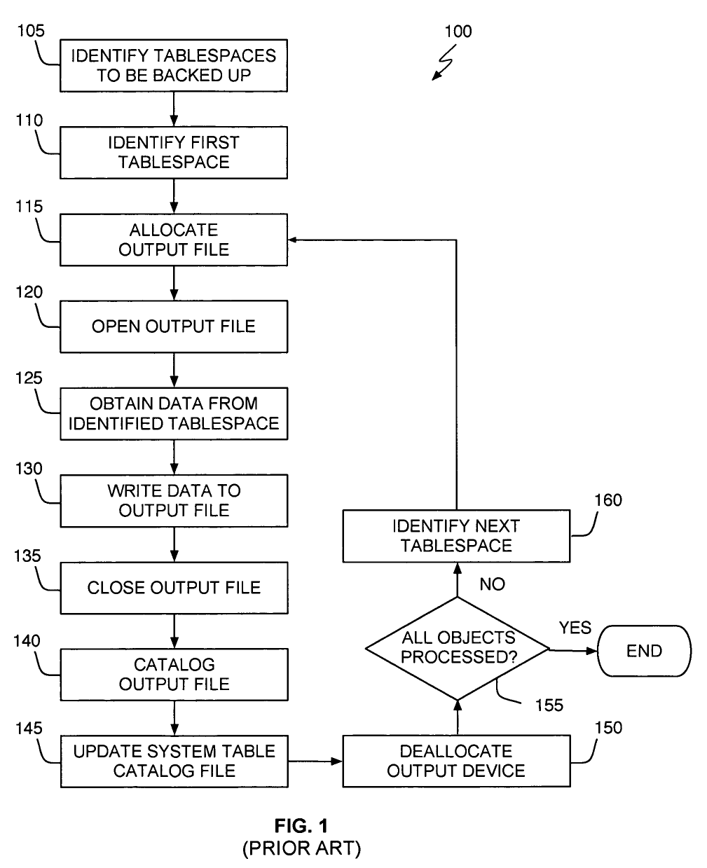

FIG. 2 shows, in flowchart form, a backup operation in accordance with one embodiment of the invention.

FIG. 3 shows, in block diagram form, information flow during a copy or backup operation in accordance with one embodiment of the invention.

FIG. 4 shows, in flowchart form, a restore operation in accordance with one embodiment of the invention.

### DETAILED DESCRIPTION

Techniques (including methods and devices) to provide relational database backup and restore operations are described. The following embodiments of the invention, described in the context of a DB2® database system, are illustrative only and are not to be considered limiting in any respect. (“DB2” is a registered trademark of the International Business Machines Corporation of Armonk, N.Y.) Techniques in accordance with the invention write a designated collection of database objects (tablespaces) to a single output file. One benefit of an operation in accordance with the invention is that it can provide a substantial reduction in the start-to-finish time required to backup, copy or image a large number of database tablespaces. Another benefit of an operation in accordance with the invention is that it reduces system or user catalog contention during backup operations by reducing the number of output file cataloging operations.

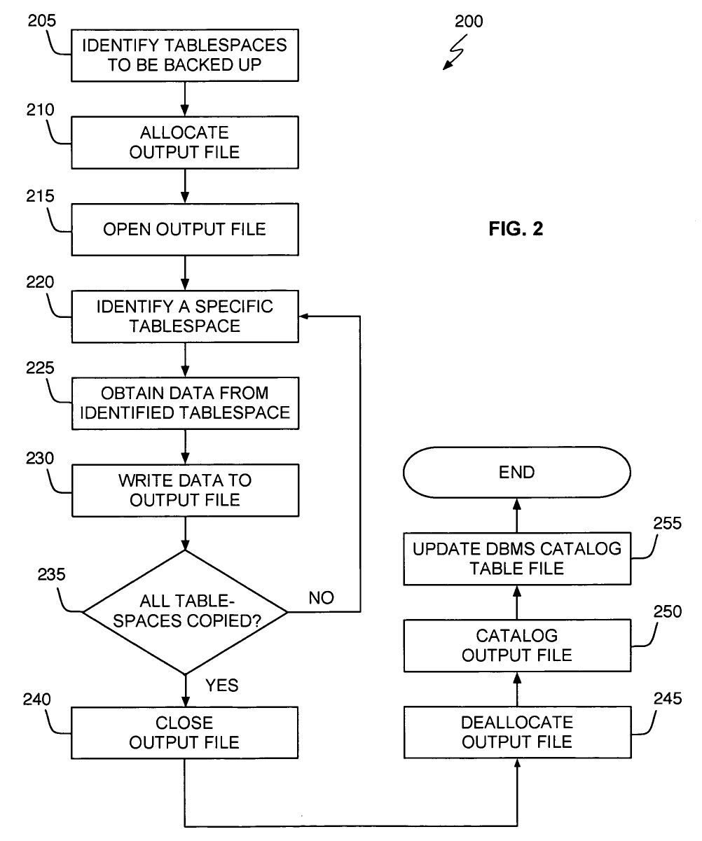

Referring to FIG. 2, in one embodiment of the invention backup process 200 copies or images a plurality of database table spaces into a single output file. In the illustrated embodiment, a user initially identifies a plurality of tablespaces to be backed up (block 205). Backup process 200 then allocates (block 210) and opens an output file in preparation to writing data therein (block 215). A first one of the identified plurality of tablespaces is then identified (block 220), the targeted data (e.g., table data or index data) is obtained (block 225) and written to the output file (block 230). If all of the tablespaces identified in accordance with block 205 have not been copied/backed up (the “No” prong of diamond 235), processing continues at block 220 where a “next” tablespace from the identified tablespaces is identified. If all of the database objects identified in accordance with block 205 have been copied/backed up (the “Yes” prong of diamond 235), the output file is closed (block 240) and deallocated (block 245). (It will be recognized that not all tablespaces identified in accordance with block 205 may be backed up, although at least two must be written to the output file in accordance with the invention.) The output file may then be cataloged (block 250). In addition, a database management system catalog is updated to reflect the completed backup operation (block 255) at which point backup process 200 is complete.

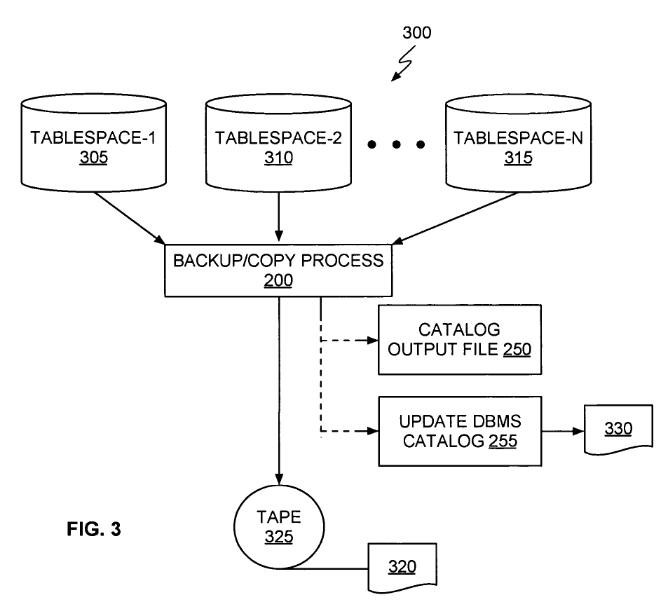

Referring now to FIG. 3, use of inventive backup process 200 in the context of DB2 database management system (DBMS) 300 will be described. As noted in FIG. 2 at block 205, a user initially identifies two or more tablespaces managed within DBMS 300 (e.g., Tablespace-1 305 and Tablespace-2 310 through Tablespace-N 315). As well-known in the art, a user may explicitly identify each tablespace or may identify a plurality of tablespaces through the use of “wildcards.” In the case of a large database backup operation, backup process 200 allocates and opens output file 320 on tape unit 325. Thereafter, information associated with each identified tablespace is obtained and sequentially written to output file 320 on tape unit 325. In one embodiment, output file 320 is a binary formatted file of a structure similar to prior art backup image files—the difference being that output file 320 includes information from a plurality of tablespaces rather than a single tablespace. Output file 320 may include only the standard metadata associated with a backup image copy or it may include identifiers denoting the end of information associated with a first tablespace and/or the start of information associated with a second tablespace. After concatenating data (information) associated with each identified tablespace into a single output file, backup operation 200 closes and deallocates output file 320 (see blocks 240 and 245 of FIG. 2).

Pursuant to block 250 of FIG. 2, output file 320 may then be cataloged so that users of DBMS 300 may access the archived datasets (copied tablespaces) by name. In a DB2 embodiment, output file 320 may be cataloged using standard operating system services such as a SVC call (in the OS/390 operating system environment). It will be recognized by one of ordinary skill in the art that it is not required to catalog the output file. This may not be done, for example, if it is determined that no user should have access to the backup image copy by name.

Pursuant to block 255 of FIG. 2, DBMS-wide catalog table file 330 is also updated upon completion of the physical copy/backup operation. In a prior art DB2 environment, for example, each backup image is cataloged in the DB2 System Catalog or SYSIBM.SYSCOPY file. It will be recognized by those of ordinary skill in the art, the SYSCOPY file is a DB2 DBMS-wide file that is used, inter alia, to record information associated with tablespace backup operations. This information allows subsequent recovery of a tablespace to a known point in time by running the RECOVER utility.

In accordance with one embodiment of the invention, catalog table file 330 is maintained by backup process 200 independent of the SYSCOPY file. For compatibility, the inventive technique tracks each tablespace (in catalog table file 330) using the same fields as the standard SYSCOPY file. However, key fields in catalog table file 330 are assigned values unique to process 200. Referring to Table 1, for example, it is noted that in one embodiment three fields identify specific attributes of a backup output file in accordance with the invention that are different from that in the prior art. While the FILESEQNO, DSNAME and STYPE fields are used in one embodiment (see table 1), more or fewer fields may be used in different embodiments. In addition, different database management systems may use a different collection of fields to track backup copy operations. Regardless of the specific type of DBMS, however, it is significant that each tablespace (or dataset) being copied is associated with a single output file identifier.

TABLE 1
System Catalog Entries
Field

| Name | Type | Comments |
|---|---|---|
| DBNAME[9] | char | Database name. |
| SPNAME[9] | char | Tablespace name. |
| DSNUM | long | Dataset or partition number. |
| ICTYPE | char | Copy type. |
| ICDATE[7] | char | Copy date. |
| START_RBA[7] | char | Copy starting Relative Byte Address |
| | | (RBA). |
| FILESEQNO | long | Tape file sequence - indicates |
| | | the position in output file 315 at |
| | | which the tablespace is stored. |
| DEVTYPE[9] | char | If not ‘catlg,’ then ‘dev’ type. |
| IBMREQD | char | IBM Required flag. |
| DSNAME[45] | char | Dataset name -- in accordance with |
| | | the invention, this value will be the |
| | | same for all datasets (tablespaces) |
| | | copied or imaged into a single output |
| | | file (e.g., file 315). |
| ICTIME[7] | char | Copy time. |
| SHRLEVEL | char | ‘Reference’ or ‘Change’. |
| TIMESTAMP[25] | char | Row timestamp. |
| ICBACKUP[3] | char | Local, remote, etc. |
| ICUNIT | char | If not ‘catlg’ the ‘copy’. |
| STYPE | char | Copy subtype -- this value will be a |
| | | unique value identifying the table- |
| | | space image as belonging to a backup |
| | | file in accordance with the invention. |
| PIT_RBA[7] | char | Point in time received to RBA. |
| GROUP_MEMBER[9] | char | Data sharing group member. |
| OTYPE | char | Object type, ‘T’ or ‘I’. |
| LOWDSNUM | long | Low affected DSNUM. |
| HIGHDSNUM | long | High affected DSNUM. |
| COPYPAGESF | double | Number copy data set pages. |
| NPAGESF | double | High-Used RBA (HURBA)/page |
| | | size. |
| CPAGESF | double | Total number of changed pages. |
| JOBNAME[9] | char | Recovery job name. |
| AUTHID[9] | char | Authorization ID of submitter. |

One benefit of a backup or copy operation in accordance with the invention is that a plurality of tablespaces may be copied into a single output file, thereby eliminating the need to allocate, open, close and deallocate a plurality of output files during the operation. In situations in which a large number of tablespaces are to be baked up at once, the inventive technique can provide tremendous time savings. Consider, for example, a backup operation of 10,000 tablespaces to a magnetic tape unit (a not unreasonable number for ERP applications). If the time required to allocate, open, close and deallocate a file is 3 seconds (not an uncommon length of time for a magnetic tape unit), a backup operation in accordance with the invention can save more than 8 hours over a comparable prior art technique—see Table 2.

TABLE 2
Backup Operation Time Comparison

Prior Art:
(10,000 files) × (3 Sec/file) + (Data Backup Time) = 8.33 Hrs +
Data backup Time
Inventive Technique:
(1 file) × (3 Sec/file) + (Data Backup Time) = 3 Sec + Data backup Time

It is significant to note that the more tablespaces identified for backup that comprise an insubstantial amount of information (that is, where the time required to allocate, open, close and deallocate a file requires a substantial fraction or more time than to backup/copy the information stored in the tablespace), the more significant the time savings (as a fraction of the end-to-end backup time) afforded by the inventive technique.

Another benefit of a backup or copy operation in accordance with the invention is that the amount of file access contention created by the backup operation can be significantly less than that generated by prior art techniques. This too can speed the backup process up and/or reduce the operational impact of a backup operation on other executing tasks.

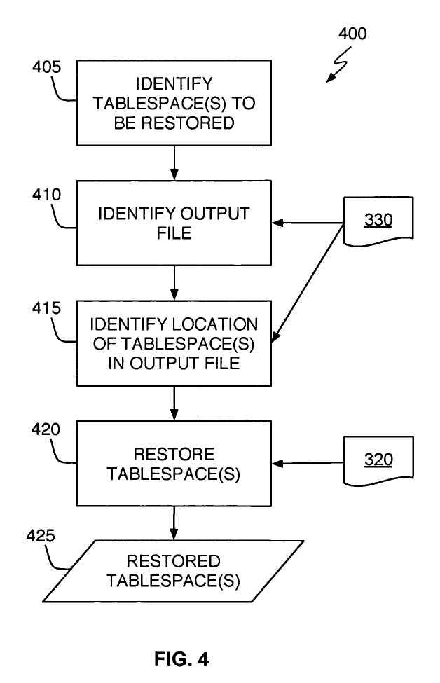

It will be recognized that backup output files (e.g., output file 320) generated in accordance with the invention (e.g., process 200) may be used for tablespace restore operations. Referring to FIG. 4, restore operation 400 in accordance with the invention identifies one or more tablespaces that are to be restored—generally through user input (block 405). Catalog table file (e.g., file 330) is then consulted to identify the output file (e.g., file 320) in which the tablespace information (i.e., table and, possibly, index data) is stored (block 410) and the location within the identified output file at which the information associated with the identified tablespaces are located (block 415). Restore operation 400 obtains the information for the identified tablespaces from the output file (block 420) to generate one or more restored tablespaces available to the targeted DBMS (block 425).

Various changes in the details of the illustrated operational methods are possible without departing from the scope of the following claims. For instance, the sequence of operations outlined in FIG. 2 may be altered without affecting the overall operation of the claimed invention. For example, the acts of block 205 may be performed after either of the acts of block 210 or 215. Similarly, a catalog table file may be updated (block 255) before it is cataloged (block 250). In addition, acts in accordance with FIGS. 2, 3 and 4 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

The preceding descriptions have been presented to enable any person skilled in the art to make and use the invention as claimed. While the illustrative embodiments described herein have been provided in the context of a DB2 database management system executing in the OS/390 operating environment, variations will be readily apparent to those skilled in the art. Accordingly, the claims appended hereto are not intended to be limited by the disclosed embodiments, but are to be accorded their widest scope consistent with the principles and features disclosed herein.

What is claimed is:

1. A relational database copy method, comprising:
identifying a plurality of tablespaces in a relational database;
gaining access to an output file;
obtaining information from each identified tablespace;
writing the information obtained from each of the identified tablespaces to the output file, one tablespace at a time;
relinquishing access to the output file; and
updating a catalog file to reflect information from the plurality of tablespaces has been written to the output file.

2. The method of claim 1, further comprising the act of cataloging the output file.

3. The method of claim 1, wherein the act of gaining access to an output file comprises:
allocating the output file; and
opening the output file.

4. The method of claim 1, wherein the act of relinquishing access to the output file comprises:
deallocating the output file; and
closing the output file.

5. The method of claim 1, wherein the act of writing comprises writing the information obtained from each of the identified tablespaces to a magnetic tape-based output file.

6. The method of claim 1, wherein the act of obtaining information from each identified tablespace comprises obtaining table data from a first tablespace.

7. The method of claim 6, further comprising obtaining index data from the first tablespace.

8. The method of claim 1, wherein the act of updating a catalog file comprises:
writing an entry in the catalog file for each tablespace whose information was written to the output file; and
associating an identifier for the output file in each such entry.

9. A database method, comprising:
gaining access to an output file;
obtaining information associated with a plurality of objects in a database;
storing the information obtained from each of the plurality of objects in the output file, wherein all data associated with a first object is written to the output file before data associated with a second object is written to the output file;
relinquishing access to the output file; and
updating a catalog file to reflect information from the plurality of objects has been written to the output file.

10. The method of claim 9, wherein the act of gaining access to an output file comprises:
allocating the output file; and
opening the output file.

11. The method of claim 9, wherein the act of relinquishing access to the output file comprises:
deallocating the output file; and
closing the output file.

12. The method of claim 9, wherein the objects comprise tablespaces from a relational database.

13. The method of claim 9, wherein at least one of the objects comprise index data.

14. The method of claim 9, wherein the output file comprises a magnetic-tape output file.

15. The method of claim 9, further comprising the act of cataloging the output file.

16. A relational database backup method, comprising:
allocating an output file;
obtaining data associated with a tablespace;
writing the data to the output file;
repeating the acts of obtaining and writing for at least one additional tablespace; and
deallocating the output file.

17. The method of claim 16, further comprising writing an entry to a relational database-wide catalog file for each tablespace backed-up, said entry identifying the tablespace and the output file.

18. The method of claim 16, further comprising the act of cataloging the output file.

19. The method of claim 16, wherein the act of allocating further comprises opening the output file.

20. The method of claim 16, wherein the act of writing comprises writing the data to a magnetic tape-based output file.

21. The method of claim 16, wherein the act of obtaining data comprises obtaining table data and index data from at least one tablespace.

22. The method of claim 16, wherein the act of deallocating further comprises closing the output file.

23. A relational database copy method, comprising:
allocating an output file on a magnetic tape storage device;
opening the output file;
obtaining data stored in at least two tablespaces in a relational database;
writing the data obtained from each tablespace to the output file, one tablespace at a time;
closing the output file;
deallocating the output file; and
updating a catalog file to reflect information from the plurality of tablespaces has been written to the output file.

24. The method of claim 23, wherein the data stored in at least two tablespaces comprise table data and index data.

25. The method of claim 23, wherein the relational database comprises a DB2 database.

26. A computer database system, comprising:
memory;
a storage device operatively coupled to the memory, said storage device having stored thereon data associated tablespaces, said tablespaces comprising a relational database;
a backup media device operatively coupled to the memory; and
a central processing unit operatively coupled to the memory, storage device and backup media device, said central processing unit adapted to execute instructions to:
identify a first plurality of tablespaces in the relational database,
acquire access to an output file on the backup media device,
obtain data from two or more of the first plurality of tablespaces,
write the obtained data to the output file, one tablespace at a time,
relinquish access to the output file, and
update a catalog file on the storage device to reflect data from the two or more tablespaces has been written to the output file.

27. The computer database system of claim 26, wherein the central processing unit is further adapted to execute instruction to catalog the output file.

28. The computer database system of claim 26, wherein the backup media device comprises a magnetic tape backup device.

29. The computer database system of claim 26, wherein the data comprises table data and index data.

30. A relational database restore operation, comprising:
identifying a plurality of tablespaces to be restored;
identifying a backup file, said backup file including data associated for all of the identified tablespaces;
restoring each of the identified tablespaces form the backup file.

31. The method of claim 30, wherein the act of identifying a backup file comprises searching a database system table catalog file, said database system table catalog file associating each of the plurality of identified tablespaces with the output file.

32. The method of claim 30, wherein the act of restoring comprises:
retrieving information from each of the identified tablespaces from the output file and
writing the retrieved information to a format compatible with a database management system.
